(19) United States
(12) Patent Application Publication
(10) Pub. No.: US 2002/0133555 A1
(43) Pub. Date: Sep. 19, 2002

(54) System and method for identifying internal and external communications in a computer network

(76) Inventors: John M. Hall, Boise, ID (US); Steve Mattis, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/810,074

(22) Filed: Mar. 15, 2001

(51) Int. Cl. G06F 15/16

(52) U.S. Cl. 709/206; 709/245

(57) ABSTRACT

A system and method for identifying whether a communication in a computer network is directed to a destination that is internal to a company includes receiving destination information associated with a first network communication. The computer network includes a directory server, which includes a company directory that provides employee information. The directory server is accessed, and the received destination information is compared with information in the company directory. It is determined whether the first network communication is directed to a destination that is internal to the company based on the comparison of the received destination information and the information in the company directory.

### FIELD OF THE INVENTION

The present invention generally relates to computer networks, and more particularly to a system and method for identifying whether network communications are directed to destinations that are internal or external to a company.

### BACKGROUND OF THE INVENTION

In addition to using a personal computer (PC) for transferring data to a network, another option for transferring information to a network is a “digital sender”. A digital sender is a network device that converts paper-based documents into electronic data. A digital sender includes a scanner for scanning in paper documents. The digital sender can send the electronic data by several methods, including via Internet e-mail and via facsimile (Fax) either through a network fax server or an Internet fax service provider.

One known manufacturer of different models of digital senders is Hewlett-Packard Company. Information regarding Hewlett-Packard digital senders is publicly available via Hewlett-Packard's website at www.hp.com. Information regarding Hewlett-Packard's digital senders is also provided in “HP 9100C Digital Sender User Guide,” 1^{st} ed., 1998, Pub. No. C1311-90910, and “HP 9100C Digital Sender Administrator Guide,” 1^{st} ed., 1998, Pub. No. C1311-90915, which are incorporated herein by reference.

A digital sender allows data to be transferred to the Internet with fewer steps than that required by a PC. The digital sender includes a keypad that allows a user to enter an e-mail address. A user can scan in a document, enter one or more e-mail addresses for the desired destinations, press a send button, and the digital sender automatically e-mails the information to the various destinations. The digital sender automatically logs onto an exchange server, and transmits an e-mail message with the scanned document attached, without any further user input required. Thus, a digital sender provides a more efficient means for transferring paper-based source information to the Internet.

It would be desirable for security purposes and other reasons to be able to identify whether particular network communications, transmitted by a digital sender or other device, are addressed to destinations that are internal or external to a company. Currently, there are a couple of options for identifying whether an email communication is internal or external to a company. A first option is to check the domain in the email address. However, this option does not work well in companies that support multiple domains. This option also does not provide for automatic updating as domains change. A second option is to maintain a list of all email addresses that are internal to a company. This method is expensive and requires a copy of the entire company or corporate directory to be maintained by the solution.

It would be desirable to be able to identify whether network communications are internal or external to a company without the disadvantages found in existing solutions.

### SUMMARY OF THE INVENTION

The present invention provides a system and method for identifying whether a communication in a computer network is directed to a destination that is internal to a company. The system and method include receiving destination information associated with a first network communication. The computer network includes a directory server, which includes a company directory that provides employee information. The directory server is accessed, and the received destination information is compared with information in the company directory. It is determined whether the first network communication is directed to a destination that is internal to the company based on the comparison of the received destination information and the information in the company directory.

### BRIEF DESCRIPTION OF THE DRAWINGS

FIG. 1 illustrates a block diagram of a network, including a network device for identifying whether communications are internal or external to a company according to the present invention.

FIG. 2 illustrates an electrical block diagram of a network device according to the present invention.

FIG. 3 illustrates examples of directory server entries.

FIG. 4 illustrates a flow diagram of destination identification operations performed by the network device according to the present invention.

FIG. 5 illustrates a flow diagram of communication transmitting operations performed by the network device according to the present invention.

FIG. 6 illustrates an email communication with an internal communication identifier added according to the present invention.

### DESCRIPTION OF THE PREFERRED EMBODIMENTS

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

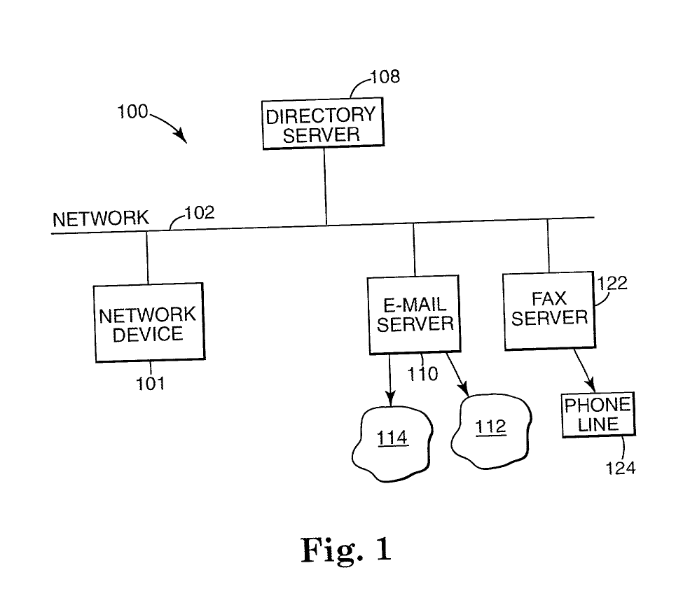

FIG. 1 illustrates a diagram of a network including a network device for identifying whether communications are internal or external to a company according to the present invention. Network 100 includes network device 101, communication link 102, directory server 108, e-mail server 110, Internet 112, Internet fax service provider 114, fax server 122, and phone line 124. In one embodiment, network device 101 is a digital sender device. In an alternative embodiment, network device 101 is a personal computer (PC) or workstation. Network device 101 may be any device capable of transmitting e-mail and/or fax communications. Network device 101 identifies whether communications are internal or external to a company based on destination information provided by a user. In one embodiment, directory server 108 is a light-weight directory access protocol (LDAP) server. E-mail server 110 preferably supports simple mail transport protocol (SMTP). In one embodiment, a permanent TCP/IP network connection exists between network device 101 and e-mail server 110.

Network device 101 allows users to send e-mail communications, with or without attachments, as well as fax communications. Network device 101 preferably includes a keyboard or other input means for entering destination information, output format information, sender information, and subject information. In one embodiment, the destination information specifies one or more email addresses and/or one or more fax phone numbers. The destination information entered by a user may specify multiple destinations for each data item to be transmitted. The output format information identifies the format for items to be sent, including e-mail format, fax format and internet fax format. The sender information provides identifying information about the sender, such as a name or e-mail address. The subject information identifies a subject of data items to be transmitted.

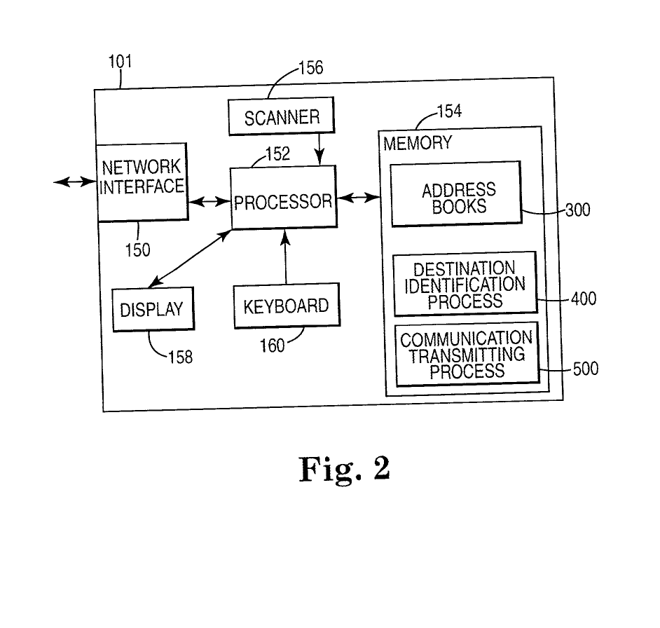

FIG. 2 illustrates an electrical block diagram of a network device according to the present invention. Network device 101 includes network interface 150, processor 152, memory 154, scanner 156, display 158, and keyboard 160. Network device 101 does not require a PC to connect to a network, but rather hooks directly into a network via network interface 150. In one embodiment, network device 101 is not server-based, which allows easier installation and configuration. Network device 101 operates as a standalone unit on network 100 and does not require network privileges to administer. Network device 101 is network operating system (NOS) independent. Network device 101 runs on any TCP-IP network, including Ethernet (10Base-T, 100Base-T or 10Base-2) or token ring.

Network interface 150 is coupled to communication link 102 of network 100, and to processor 152. Network device 101 transmits communications through network interface 150 to network 100. Network device 101 also receives communications from network 100 through network interface 150. Network interface 150 passes the received communications on to processor 152.

Data is entered into network device 101 by a user via keyboard 160. Data is displayed by network device 101 via display 158. Alternative methods of data entry and display may be used, including a touch screen display.

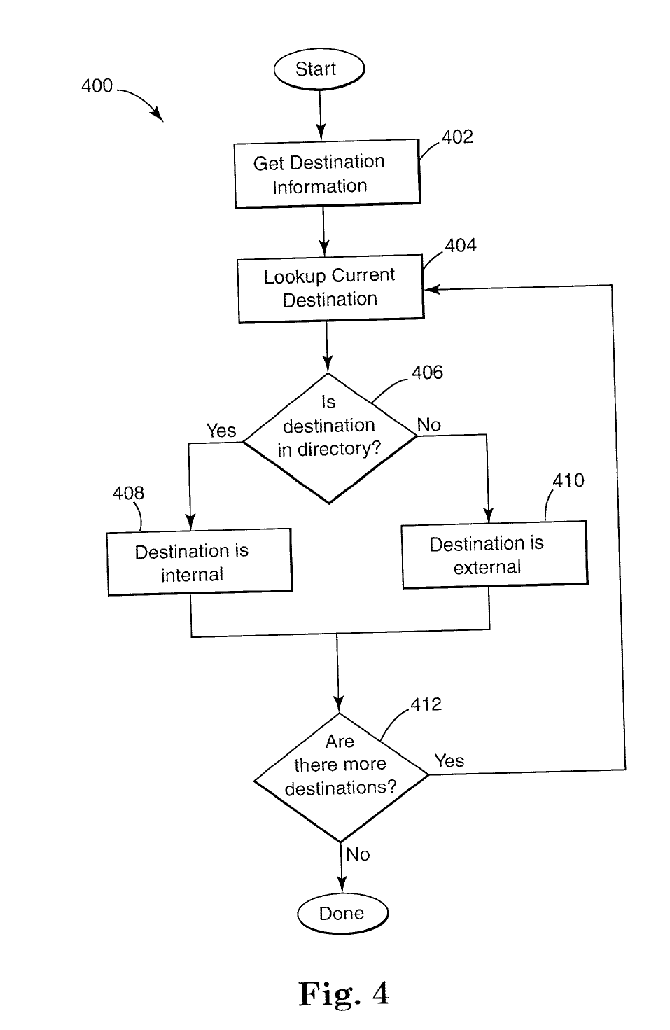

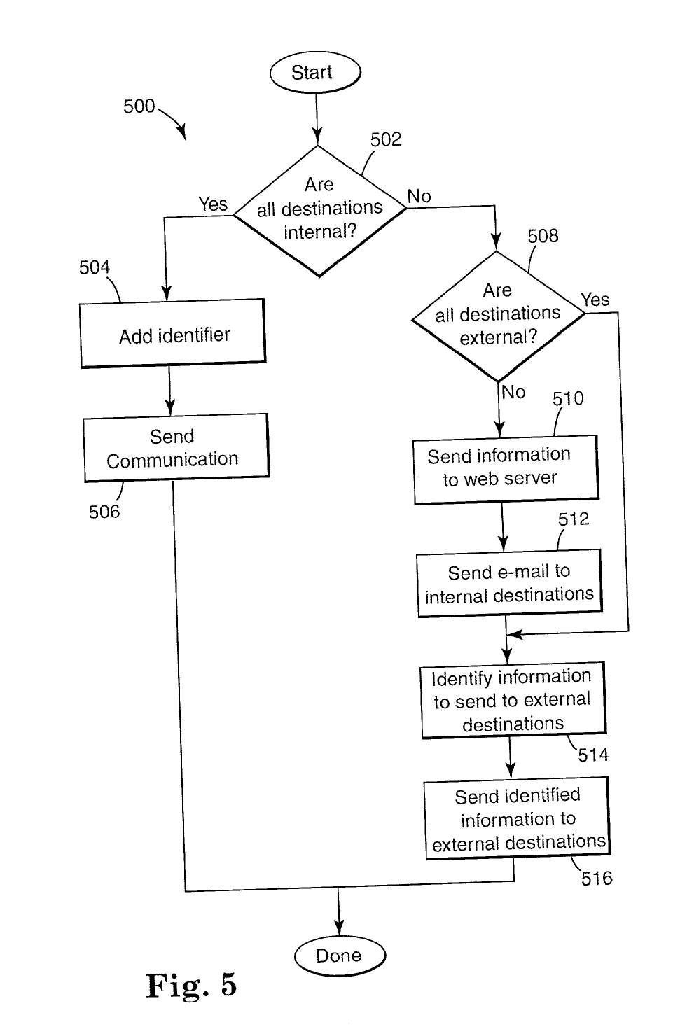

Users provide input data items to network device 101, such as a paper-based document, and processor 152 generates one or more output data items based on the input data items, and on the entered destination information, output format information, sender information, and subject information. Memory 154 stores information provided by a user, one or more internal address books 300, destination identification process 400 (shown in flow diagram form in FIG. 4), and communication transmitting process 500 (shown in flow diagram form in FIG. 5).

In one embodiment, an output data item generated by processor 152 takes the form of an e-mail message. An e-mail message generated by processor 152 preferably includes two parts. The first part is a header, which contains sender and destination information. The second part is a digitized document attachment. Scanner 156 generates the digitized document by converting a paper-based document into a digital document format, such as PDF or TIFF format. The type of document format is specified in the output format information entered by a user. The PDF (or TIFF) file is attached to an e-mail message by processor 152. Processor 152 preferably uses multi-part Internet message encoding (MIME) to encode e-mail messages. Email addresses may be entered via keyboard 160 on network device 101, or they can be retrieved from an internal address book 300 stored in memory 154. In addition, network device 101 also supports LDAP queries, which provides the ability of real-time address queries. The LDAP capabilities are provided by directory server 108.

Network device 101 includes the capability to send faxes. Fax server 122 includes phone line 124 to fax communications received from network device 101. Fax server 122 handles outbound dialing to fax communications received from network device 101 over phone line 124. Fax numbers may be entered via keyboard 160 on network device 101, or they can be retrieved from an internal address book 300 stored in memory 154.

Network device 101 is also capable of sending faxes via the Internet. To provide Internet fax capabilities, the user must subscribe to an Internet fax service provider service. E-mail server 110 provides Internet fax capabilities using Internet fax service provider 114. In order to transmit a document via Internet fax, network device 101 transmits a communication via communication link 102 to e-mail server 110, which handles the Internet fax transmission. Internet fax destinations are entered in network device 101 via keyboard 160, or they can be retrieved from an internal address book 300 stored in memory 154.

After the appropriate information is entered by a user into network device 101 to send a communication, network device 101 communicates with directory server 108 to determine whether communications are directed to destinations that are internal or external to a company. Directory server 108 contains descriptive, attribute-based information. The service model of directory server 108 is based on entries. An entry is a collection of attributes that has a name, which is referred to as a distinguished name (DN). A DN uniquely identifies an entry. Each of the entry's attributes has a type and one or more values. Types are typically mnemonic strings, like “name” for a person's name, or “Email” for a person's email address. The values depend on what type of attribute it is. For example, an Email attribute might contain the value “joe@computer.com”. In one embodiment, the directory entries in directory server 108 are arranged in a hierarchical tree-like structure.

Directory server 108 provides operations for interrogating and updating the directory. Operations are provided for adding and deleting an entry from the directory, changing an existing entry, and changing the name of an entry. Directory server 108 is also used to search for information in the directory. A search operation allows some portion of the directory to be searched for entries that match some criteria specified by network device 101. Information can be requested from each entry that matches the criteria.

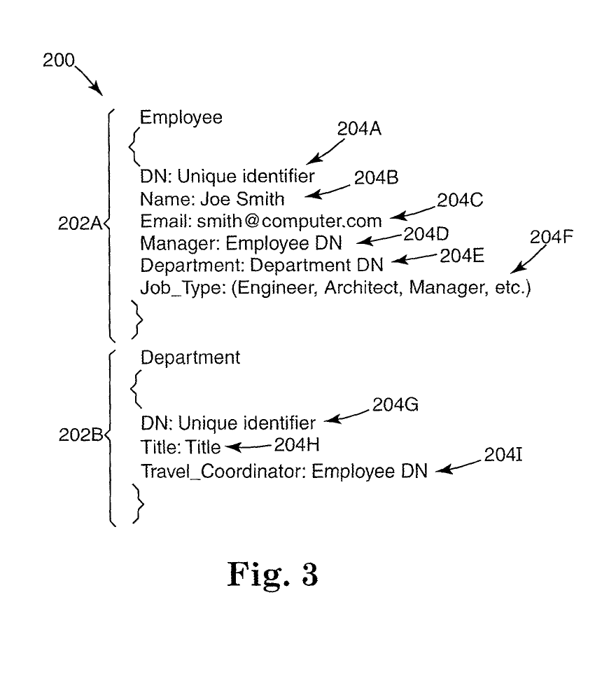

FIG. 3 illustrates examples of directory server entries in directory server 108. Entries 200 in directory server 108 include entries 202A and 202B. Entries 202A and 202B include attributes 204A-204I (collectively referred to as attributes 204). In the embodiment shown, entry 202A is an “Employee” entry, and entry 202B is a “Department” entry. Employee entry 202A includes distinguished name (DN) attribute 204A, name attribute 204B, email attribute 204C, manager attribute 204D, department attribute 204E, and job_type attribute 204F. Department entry 202B includes DN attribute 204G, title attribute 204H, and travel_coordinator attribute 204I. Entry 202A is uniquely identified by its DN attribute 204A. Entry 202B is uniquely identified by its DN attribute 204G. Each attribute 204 includes a value. For example, the value for email attribute 204C might be “smith@computer.com”, the value for job_type attribute 204F might be one of “Engineer”, “Architect,” or “Manager,” and so on.

Entries 200 represent an employee record for a single employee, and are also referred to as employee record 200. Similar entries are provided for other employees. Other types of information may also be specified in entries 200. Note that the department entry 202B may only be stored once in directory server 108, but may be referenced by multiple employee entries 202A via department attribute 204E.

In one embodiment, directory server 108 is internal to a company and stores a company directory for just that company. In an alternative embodiment, directory server 108 is external to a company and stores multiple company directories for multiple companies. The company directory includes employee records 200 for the employees of the company.

FIG. 4 illustrates a flow diagram of destination identification operations performed by network device 101 according to the present invention. Destination identification process 400 is stored in memory 154 of network device 101 (shown in FIG. 2). The first step in process 400 is network device 101 receiving destination information for a communication. (Block 402). Processor 152 accesses directory server 108, and looks up a destination specified in the received destination information in the company directory of directory server 108. (Block 404). For a directory server 108 that is external to a company and that stores company directories for multiple companies, processor 152 would specify both a company attribute and an email attribute (or fax attribute) in a search of the directory server 108. For a directory server 108 that is internal to a company and that stores a company directory only for that company, processor 152 would specify an email attribute (or fax attribute) in a search of the directory server 108, but would not need to specify a company attribute. For the specified destination, processor 152 determines whether the destination is contained within the company directory of directory server 108. (Block 406). If the specified destination is contained within the company directory, the destination is identified by processor 152 as a destination that is internal to the company. (Block 408). If the destination is not contained within the company directory, the destination is identified by processor 152 as a destination that is external to the company. (Block 410). Processor 152 next determines whether the received destination information specifies any other destinations. (Block 412). If additional destinations are specified, processor 152 jumps to Block 404, and repeats the process for each specified destination.

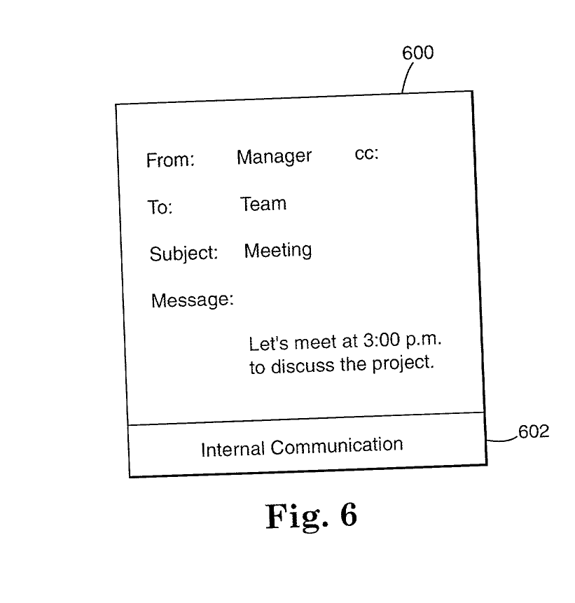

In one embodiment, after identifying destinations in a communication as being either internal or external to a company, processor 152 performs additional processing on the communication based on the identifications. FIG. 5 illustrates a flow diagram of operations performed by network device 101 in one embodiment, after destinations in a communication are identified as either internal or external. Communication transmitting process 500 is stored in memory 154 of network device 101 (shown in FIG. 2). A first step in communication transmitting process 500 is to determine whether all destinations specified in the destination information for a communication are internal to a company. (Block 502). For a communication that specifies only internal destinations, processor 152 preferably adds an identifier to the communication to indicate that the communication is for internal use only. (Block 504). The identifier may take many forms, including a watermark, icon, text, or other form that indicates that the communication is internal to the company. FIG. 6 illustrates an example of an email communication 600 after a text identifier 602 has been added by processor 152 to the communication. Text identifier 602 indicates that all of the recipients of the email communication are internal to the company. Similar external identifiers could be added to communications directed to external destinations.

In one embodiment, for a communication that specifies one or more external destinations, processor 152 modifies the communication so that external recipients are treated differently than internal recipients. If a communication does not specify all internal destinations (Block 502), processor 152 next determines whether the communication specifies all external destinations. (Block 508). If a communication specifies all external destinations, processor 152 jumps to block 514. If a communication specifies one or more internal destinations and one or more external destinations, processor 152 sends information from the communication to a web server. (Block 510). Processor 152 then sends an email communication to each specified internal destination, and includes in each of the email communications a uniform resource locator (URL) identifying the location of the information on the web server. The web server may be placed behind a firewall so that only company employees have access to the web server. For external destinations, processor 152 identifies information in the communication to be sent to the external destinations. (Block 514). The content sent to external destinations may be different than the content sent to internal destinations. Processor 152 sends the identified information from the communication via email to each specified external destination. (Block 516). One of ordinary skill in the art will realize that other modifications to a communication may be made to provide different communications to different types of destinations.

It will be understood by a person of ordinary skill in the art that functions performed by network device 101 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory. In addition, it will be understood that the functionality in network device 101 of identifying internal and external destinations, and modifying communications based on the identification may be implemented in a separate stand-alone device, rather than being made part of network device 101. It will also be understood by one of ordinary skill in the art that the techniques disclosed herein are not limited to e-mail and fax communications, but may be applied to any other network communications as well.

The present invention provides the ability to identify whether network communications are internal or external to a company. The invention works in companies that use single or multiple domains. The invention works with addresses that are not in a static database, and does not require maintenance of a second company directory. The behavior of the invention is automatically updated as the company directory changes.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of identifying whether a communication in a computer network is directed to a destination that is internal to a company, the computer network including a directory server, the directory server including a company directory that provides employee information, the method comprising:
receiving destination information associated with a first network communication;
accessing the directory server and comparing the received destination information with information in the company directory; and
determining whether the first network communication is directed to a destination that is internal to the company based on the comparison of the received destination information and the information in the company directory.

2. The method of claim 1, and further comprising:
adding an identifier to the first network communication to indicate whether the first network communication is directed only to destinations internal to the company.

3. The method of claim 1, wherein the destination information specifies at least one email address.

4. The method of claim 3, and further comprising:
determining whether the specified at least one email address is contained within the company directory, and
determining whether the first network communication is directed to a destination that is internal to the company based on the determination of whether the specified at least one email address is contained within the company directory.

5. The method of claim 1, wherein the destination information specifies at least one fax phone number.

6. The method of claim 5, and further comprising:
determining whether the specified at least one fax phone number is contained within the company directory, and
determining whether the first network communication is directed to a destination that is internal to the company based on the determination of whether the specified at least one fax phone number is contained within the company directory.

7. The method of claim 1, wherein the destination information specifies a plurality of destinations, the method further comprising:
identifying whether each of the plurality of destinations is internal to the company based on a comparison of the received destination information and the information in the company directory.

8. The method of claim 7, and further comprising:
adding an identifier to the first network communication to indicate whether the first network communication is directed only to destinations internal to the company.

9. The method of claim 7, and further comprising:
adding an identifier to the first network communication to indicate whether the first network communication is directed to at least one destination external to the company.

10. The method of claim 7, and further comprising:
transmitting at least a portion of the first network communication via email to destinations identified as external to the company; and
transmitting at least a portion of the first network communication to a web server.

11. The method of claim 10, and further comprising:
transmitting an email communication to destinations identified as internal to the company, the email communication including link information for accessing the information transmitted to the web server.

12. The method of claim 1, wherein the directory server is an LDAP server.

13. The method of claim 7, and further comprising:
transmitting a first version of the first network communication to destinations identified as internal to the company; and
transmitting a second version of the first network communication to destinations not identified as internal to the company, the second version differing in content from the first version.

14. The method of claim 7, and further comprising:
transmitting a version of the first network communication via a first communication method to destinations identified as internal to the company; and
transmitting a version of the first network communication via a second communication method to destinations not identified as internal to the company, the second communication method differing from the first communication method.

15. A network device configured to be coupled to a computer network having a directory server, the network device comprising:
a receiver for receiving destination information associated with a first network communication; and
a controller configured to perform a search of the directory server based on the received destination information and determine whether the destination information specifies a destination that is internal to a first company based on the search.

16. The network device of claim 15, and further comprising a memory coupled to the controller, the memory storing a destination identification process, and wherein the controller is configured to determine whether the destination information specifies a destination that is internal to a first company based on the destination identification process.

17. The network device of claim 15, wherein the controller is configured to add an identifier to the first network communication to indicate whether the first network communication is directed only to destinations internal to the first company.

18. A computer-readable medium having computer-executable instructions for performing a method of identifying whether a communication in a computer network is directed to a destination that is internal to a company, the computer network including a directory server, the directory server including a company directory that provides employee information, comprising:
receiving destination information associated with a first network communication;
accessing the directory server and comparing the received destination information with information in the company directory; and
determining whether the first network communication is directed to a destination that is internal to the company based on the comparison of the received destination information and the information in the company directory.

19. The medium of claim 18, wherein the method further comprises:
adding an identifier to the first network communication to indicate whether the first network communication is directed only to destinations internal to the company.

20. The medium of claim 18, wherein the destination information specifies at least one email address.

21. The medium of claim 20, wherein the method further comprises:
determining whether the specified at least one email address is contained within the company directory, and
determining whether the first network communication is directed to a destination that is internal to the company based on the determination of whether the specified at least one email address is contained within the company directory.
